(19) United States
(12) Patent Application Publication
(10) Pub. No.: US 2002/0131274 A1
(43) Pub. Date: Sep. 19, 2002

(54) Vehicle-wheel light assembly

(76) Inventor: Anthony J. Pittello, Los Angeles, CA (US)

Correspondence Address: Albert O. Cota, A-331, 5460 White Oak Ave., Encino, CA, 91316, US

(21) Appl. No.: 09/759,878

(22) Filed: Jan. 16, 2001

(51) Int. Cl. F 21W 1 1/00

(52) U.S. Cl. 362/500; 362/802

(57) ABSTRACT

A vehicle-wheel light assembly (10) that is attached to a tire valve stem (90) projecting from a vehicle wheel (92). The assembly (10) consists of four elements; a housing (12) having an upper section (14) and a lower section (26), a set of batteries (50), a light emitting diode (LED) (60), and a single-pole, single-contact centrifuge switch (70). The housing (12) is dimensioned to enclose all the elements of the assembly (10) with the LED (60) projecting from an upper end (16) of the upper section (14) and with the lower section (26) having a lower end (32) which includes a set of threads (34) dimensioned to be threaded onto the threads of the tire valve stem (90). When the vehicle wheel rotates a centrifugal force is produced which causes the switch (70) to close. The closed switch allows current from the batteries (58) to be applied to and cause the LED (60) to illuminate. When the centrifugal force drops below a predetermined amount, the switch (70) opens causing the LED (60) to stop illuminating.

### TECHNICAL FIELD

The invention pertains to the general field of vehicle illumination devices and more particularly to a light assembly, that is attached to a tire valve stem and that illuminates only when the vehicle wheel is rotating.

### BACKGROUND ART

Previously, there have been items available for adding illumination to a vehicle. In addition to headlights, turn signal indicators, reverse/brake lights and (in some countries) side marker lights, there are lights for illuminating a license plate or the ubiquitous fog lights, which now come standard on many vehicles after being sold for years as an aftermarket accessory. For a person who wishes to customize their vehicle, the use of lights can add decorative, dramatic and highly visible alterations, without having to make major changes to the vehicle itself.

Another method that people use to customize or improve their vehicle, is to change the wheels and/or tires. For some reason, a person who would not alter any other aspect of their vehicle feels the need to change the wheels or tires. The reason for this is because wheel/tires are one of the primary focus points on a vehicle, and people often gauge a vehicle by its wheels.

If there were some way of combining the improvement/upgrading of wheels, with the addition of illumination, it would provide an excellent means of customizing. Additionally, as previously stated, most light additions to vehicles are relatively easy; if lights were available for wheels that could be easily attached and were maintenance free, they would benefit individualistic vehicle owners.

A search of the prior art did not disclose any patents that read directly on the claims of the instant invention however, the following U.S. patents were considered related:

| U.S. Pat. No. | INVENTOR | ISSUED |
|---|---|---|
| 6,119,714 | Otzen | September 19, 2000 |
| 6,102,064 | Robinson | August 15, 2000 |
| 6,089,251 | Pestel | July 18, 2000 |
| 5,341,833 | Davis | August 30, 1994 |

The U.S. Pat. No. 6,119,714 patent issued to Otzen discloses a valve cap for an installation having interior air pressure. The cap includes an upper sleeve portion with a central recess for receiving a pair of pressure indicating inserts. The inserts are received in the recess, and each displays one digit of a desired inflation pressure on its upper surface. The inserts also have a formation thereon which enable them to be snapped snugly in place within the recess.

The U.S. Pat. No. 6,102,064 patent issued to Robinson discloses a theft resistant valve cap including a liner adapted for threaded engagement with a standard pneumatic tire stem valve, a sleeve rotatably mounted with the liner to shroud it and an interlocking feature to selectively prevent axial displacement between the liner and the sleeve. The interlocking feature includes a screw threaded into an aperture in the sleeve, or other coupling device, and an annular channel on the liner, positioned to receive the screw. The screw can be removed after the valve cap has been installed, in this fashion, the liner and the sleeve are in a fixed axial position with respect to each other.

The U.S. Pat. No. 6,089,251 patent issued to Pestel discloses a pneumatic valve that is partially embedded in an aperture in a flexible wall of an inflatable object. The pneumatic valve consists of a valve body containing a valve mechanism and two collars which surround and grip the valve body. The two collars are removably attached to the valve body, and a sealing means is provided between a lower ring and the valve body. Fitting the valve to or removing it from the flexible wall can be carried out entirely from the exterior of the flexible wall.

The U.S. Pat. No. 5,341,833 patent issued to Davis discloses a tire valve cap for a flush mounted tire valve which seals the tire valve against external debris and internal leakage. Slits located in the wall of the cap allow the cap to act like a spring after insertion and to permit any internal leakage to intensify the sealing properties of the cap to the valve.

### DISCLOSURE OF THE INVENTION

The vehicle wheel light assembly consists of an add-on decorative lamp which is easily attached to the tire valve stem of a vehicle wheel. The assembly incorporates a centrifuge-type switch which closes when the wheel is in motion thus, causing the lamp to illuminate.

In its most basic form, as shown in FIG. 2, the vehicle-wheel light assembly consist of four elements:

a) A housing having means for being attached to a threaded tire valve stem,

b) A battery located within the housing and having a positive terminal and a negative terminal,

c) A lamp having means for being attached to the housing and having a first terminal and a second terminal, wherein the first terminal is connected to the positive terminal of the battery, and

d) A single-pole, single-contact centrifuge switch located within the housing. The pole of the switch is connected to the second terminal of the lamp and the contact is connected to the negative terminal of the battery. The switch is designed to close when a sufficient centrifugal force is applied by the rotation of the vehicle wheel, wherein when the switch closes, the lamp illuminates. Conversely, when the centrifugal force produced by the rotating wheel is less than a predetermined amount the switch opens causing the lamp to stop illuminating.

The housing which is made of metal or a high-impact plastic, is dimensioned to enclose the four elements as described above. The means for attaching the housing to the tire valve stem consists of a set of threads located on the lower end of the housing that are cut to interface with the threads on the tire valve stem. The lamp which preferably consists of a light emitting diode (LED) protrudes from the upper end of the housing and can be selected in various colors.

The power to operate the lamp is provided by the battery which preferably consists of a set of button-type batteries that easily fit into a battery-accessible compartment located adjacent the lower end of the housing. The battery voltage is applied to the LED by the single-pole, single-contact centrifuge switch. The switch can only close when a sufficient centrifugal force is applied by the rotation of the vehicle wheel. When the switch closes power is applied to the lamp thus causing the lamp to illuminate. Conversely, when the centrifugal force produced by the rotating wheel is less than a predetermined amount the switch opens causing the lamp to stop illuminating.

The housing can be designed with a lower section having an articulating section which can include a flexible material, such as found on a “gooseneck” lamp or a universal-type structure. The articulating structure allows the housing of the vehicle-wheel light assembly to be positioned in a direction which optimizes the illumination of the lamp.

In view of the above disclosure it is the primary object of the invention to produce a vehicle-wheel light assembly that is easily attached to a tire valve stem and that illuminates only when the vehicle wheel rotates.

In addition to the primary object of the invention, it is also an object of the invention to produce a vehicle-wheel light assembly that:

produces a decorative light effect,

can be made with various color lights,

is easily interchangeable,

is reliable, and

is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is an elevational-side view showing the vehicle-wheel light assembly attached to a tire valve stem projecting outward from a vehicle wheel.

FIG. 2 is a schematic diagram showing the basic elements that comprise the vehicle-wheel light assembly.

FIG. 3 is a side-elevational wiring/structural diagram of the vehicle-wheel light assembly which includes a lower section having a corrugated structure which allows the assembly to be positioned at an angle which optimizes the illumination of the lamp.

FIG. 4 is a partial side-elevational view showing the upper section of the housing separated from the lower section by a universal-type structure which allows the assembly to be positioned at an angle which optimizes the illumination of the lamp.

### BEST MODE FOR CARRYING OUT THE INVENTION

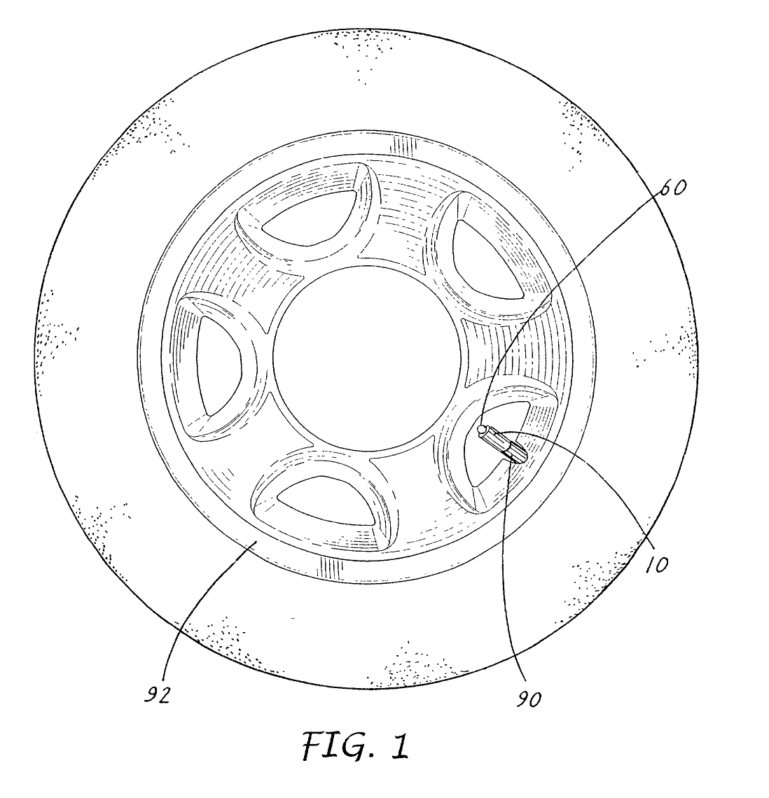

The best mode for carrying out the invention is presented in terms of a preferred embodiment for a vehicle wheel light assembly 10, (hereinafter “assembly 10”). The assembly 10 is designed to be attached to a vehicle's threaded tire valve stem 90, which projects outward from a vehicle's wheel 92, thus producing unique illumination as the tire rotates. The assembly 10 is shown attached to the valve stem 90 in FIG. 1. The assembly 10, as shown in FIGS. 1-4, is comprised of a housing 12 and a lamp, which preferably consists of at least one light emitting diode (LED) 60.

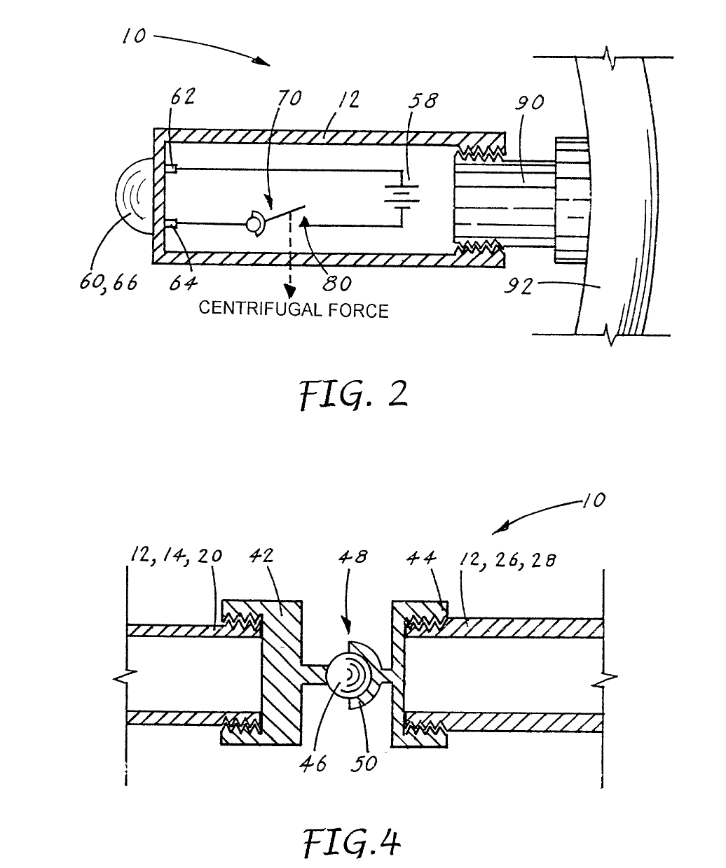

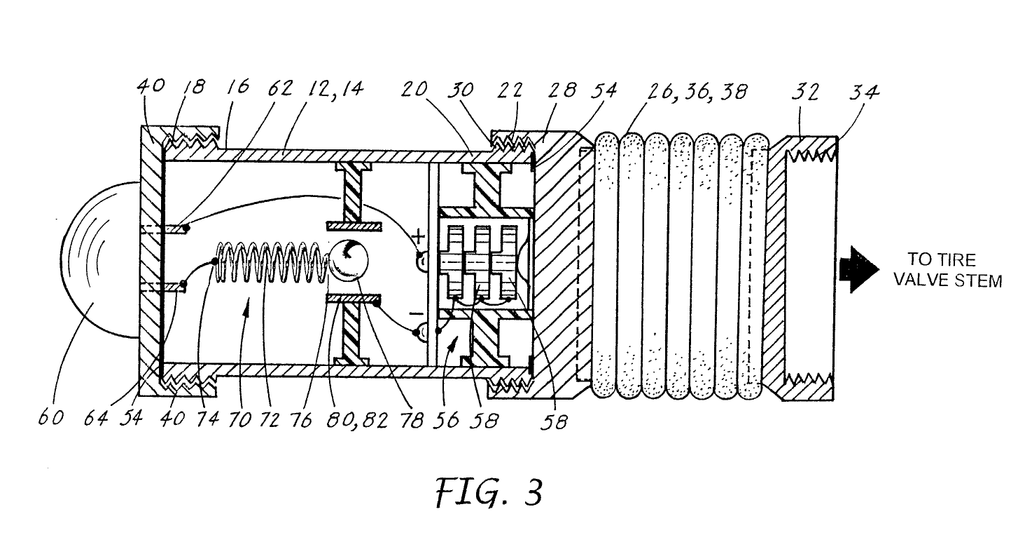

The housing 12, as shown in FIGS. 2 and 3 is comprised of an upper section 14 with an upper end 16 in having a set of external threads 18, and a lower end 20 having a set of external threads 22. A lower section 26 has an upper end 28 having a set of internal threads 30, and a lower end 32 having a set of internal threads 34. The internal threads 30 on the upper end 28 of the lower section 26 are dimensioned to be threaded into the lower end 20 of the upper section 14. The internal threads 34 on the lower end 32 of the lower section 26 are dimensioned to be threaded onto the threaded tire stem 90.

The lower section 26 is constructed of a flexible material 36, which can be comprised of a corrugated “gooseneck” section 38, as shown in FIG. 3. The “gooseneck” section allows the housing 12 to be positioned to face outward in any direction, thus optimizing the illumination from the LED 60. As shown in FIG. 3, the assembly 10 further comprises an o-ring 54, which is placed between each set of threaded pairs on the housing 12 to prevent moisture from entering the housing.

As also shown best in FIG. 3, adjacent the lower end 20 of the housing's upper section 14 is formed a battery compartment 56. Located within the battery compartment 56 is a battery, such as a set of button-type batteries 58. The batteries 58 are connected in series and have a positive terminal and a negative terminal.

The LED 60, as shown in FIG. 3, has a first pin 62, and a second pin 64. The LED 60 is attached to a threaded LED cap 40, with the two pins 62, 64 extending inward, and the first pin 62 connected to the positive terminal of the batteries 58. The threaded LED cap 40 has a set of internal threads that are dimensioned to be threaded onto the external threads 18 on the upper end 16 of the upper section 14 of the housing 12.

As shown in FIGS. 2 and 3, a single-pole, single-contact centrifuge switch 70 is located within the upper section 14 of the housing 12, between the LED 60 and the batteries 58. The “single pole” in a preferred design, is comprised of an electrically-conductive spring 72 having an outer end 74 and an inner end 76. The outer end 74 is connected to the second pin 64 of the LED 60, and the inner end 76 is attached to an electrically-conductive ball 78. The “single contact” is preferably comprised of an electrically-conductive cylinder 80, which is connected to the negative terminal of the batteries 58. The electrically-conductive cylinder 80 is positioned within the housing 12 such that when the vehicle wheel is not rotating, the conductive ball 78 is substantially and concentrically centered within the cylinder 80 as shown in FIG. 3. When the vehicle wheel rotates, a centrifugal force is applied to the spring pole, which causes the conductive ball 78 to be displaced and make electrical contact with the walls of the cylinder 80. Once the conductive ball 78 makes contact, the switch 70 closes, allowing the current from the batteries 58 to flow and cause the LED 60 to illuminate. Conversely, when the centrifugal force produced by the rotating vehicle wheel is less than a pre-determined amount, the switch 70 opens, thus causing the LED 60 to no longer illuminate.

As shown in FIG. 4, the lower end 20 of the upper section 14 of the housing 12 is terminated with an upper section threaded cap 42 from where projects a ball section 46 of a universal-type structure 48. The upper end 28 of the lower section 26 of the housing 12 terminates with a lower section threaded cap 44 from where projects a ball-receptor section 50 of the universal-type structure 48. By utilizing the universal-type structure 48, the housing 12 can be positioned to face outward in any direction, thus optimizing the illumination from the assembly 10.

Additionally, if desired, the LED 60 can incorporate a built-in blinking circuit 66, as shown in FIG. 2, which causes the LED 60 to blink when power is applied.

While the invention has been described in complete detail and pictorially shown in the accompanying drawings it is not to be limited to such details, since many changes and modifications may be made to the invention without departing from the spirit and the scope thereof. Hence, it is described to cover any and all modifications and forms which may come within the language and scope of the claims.

1. A vehicle-wheel light assembly adapted to be attached to a threaded tire valve stem projecting outward from a vehicle wheel, said assembly comprising:
a) a housing having means for being attached to the threaded tire valve stem,
b) a battery located within said housing and having a positive terminal and a negative terminal,
c) a lamp having means for being attached to said housing and having a first pin and a second pin, wherein the first pin is connected to the positive terminal of said battery, and
d) a single-pole, single-contact centrifuge switch located within said housing, wherein the pole is connected to the second pin of said lamp and the contact is connected to the negative terminal of said battery, wherein said switch is designed to close when a sufficient centrifugal force is applied by the rotation of the vehicle wheel, wherein when said switch closes, said lamp illuminates, conversely, when the centrifugal force produced by the rotating wheel is less than a predetermined amount said switch opens causing said lamp to stop illuminating.

2. The assembly as specified in claim 1 wherein said means for attaching said housing to the threaded tire valve and for attaching said lamp to said housing is accomplished by said housing having:
a) an upper end and a lower end, wherein the lower end has a set of internal threads dimensioned to be threaded into the threaded tire valve stem, and
b) a cap having a bore dimensioned to accept and retain said lamp, wherein said cap is attached by, an attachment means, to the upper end of said housing.

3. The assembly as specified in claim 2 wherein said means for attaching said cap to the upper end of said housing comprises: said cap having a set of internal threads and the upper end of said housing having a set of external threads, into which said cap is threaded.

4. The assembly as specified in claim 1 wherein said battery is comprised of a set of button-type batteries which are connected in series to provide the required voltage to operate said lamp.

5. The assembly as specified in claim 4 wherein said housing is comprised of two sections:
(a) an upper section having an upper end and a lower end, and
(b) a lower section having an upper end and a lower end, wherein the lower end of the upper section and the upper end of the lower section have mating threads which allow the two sections to be attached, wherein near the lower end of the upper section is formed a compartment which allows access to said batteries, wherein the lower end has set of internal threads dimensioned to be threaded onto the threaded valve stem.

6. The assembly as specified in claim 2 further comprising an o-ring placed between each set of threaded pairs on said housing, wherein said o-ring prevent moisture from entering said housing.

7. The assembly as specified in claim 5 wherein said lower section of said housing is constructed of a flexible material which allows said housing to be positioned to face-outward in any direction to optimize the illumination of said lamp.

8. The assembly as specified in claim 7 wherein said flexible material is comprised of a corrugated “gooseneck” section.

9. The assembly as specified in claim 5 wherein the lower end of the upper section of said housing terminates in a ball section of a universal type structure, and wherein the upper end of the lower section of said housing terminates in a ball-receptor section of said universal-type structure, wherein said universal-type structure allows said housing to be positioned to face-outward in any direction to optimize the illumination of said lamp.

10. The assembly as specified in claim 1 wherein said lamp is comprised of at least one light emitting diode (LED).

11. The assembly as specified in claim 10 wherein said LED incorporates a built-in blinking circuit which causes said LED to blink when power is applied.

12. The assembly as specified in claim 2 wherein said single-pole, single-contact centrifuge switch comprises:
a) the single-pole comprising an electrically-conductive spring having an outer end and an inner end, wherein the outer end is connected to the second pin of said lamp and the inner end is attached to an electrically conductive ball, and
b) the single-contact comprising an electrically conductive cylinder connected to the negative terminal of said battery and positioned within said housing such that when the vehicle wheel is not rotating, the conductive ball is substantially and concentrically centered within the cylinder, wherein when the vehicle wheel rotates a centrifugal force is applied to the conductive spring pole which causes the conductive ball to be displaced and make electrical contact with the cylinder walls which close the switch causing said lamp to illuminate, conversely when the centrifugal force produced by the rotating vehicle wheel is less than a predetermined amount said switch opens causing said lamp to stop illuminating.

13. A vehicle-wheel light assembly adapted to be attached to a threaded tire valve stem projecting outward from a vehicle wheel, said assembly comprising:
a) a housing having:
(1) an upper section with an upper end having a set of external threads and a lower end having a set of external threads,
(2) a lower section with an upper end having a set of internal threads and a lower end having a set of internal threads, wherein the threads on the upper end of the lower section are dimensioned to be threaded into the lower end of the upper section, and wherein the threads on the lower end of the lower section are dimensioned to be threaded onto the threaded tire valve, wherein adjacent the lower end of the upper section is formed a battery compartment,
b) a set of button-type batteries connected in series and having a positive terminal and a negative terminal, wherein said batteries are located within the battery compartment,
c) at least one light emitting diode (LED) having a first pin and a second pin, wherein said LED is attached to a cap with the two LED pins extending inward, wherein the first pin is connected to the positive terminal of said batteries, said cap having a set of internal threads dimensioned to be threaded onto the external threads on the upper end of the upper section of said housing, and
d) a single-pole, single-contact centrifuge switch located within the upper section of said housing between said LED and said set of batteries, wherein the single pole comprises an electrically-conductive spring having an outer end and an inner end, wherein the outer end is connected to the second pin of said LED and the inner end is attached to an electrically conductive ball, wherein the single-contact is comprised of an electrically conductive cylinder connected to the negative terminal of said set of batteries and positioned within said housing such that when the vehicle wheel is not rotating, the conductive ball is substantially and concentrically centered within the cylinder, wherein when the vehicle wheel rotates a centrifugal force is applied to the conductive spring pole which causes the conductive ball to be displaced and make electrical contact with the cylinder walls which closes the switch, allowing current from said set of batteries to flow to and cause said LED to illuminate, conversely, when the centrifugal force produced by the rotating vehicle wheel is less than a predetermined amount said switch opens causing said LED to stop illuminating.

14. The assembly as specified in claim 13 further comprising an o-ring placed between each set of threaded pairs on said housing, wherein said o-ring prevents moisture from entering said housing.

15. The assembly as specified in claim 13 wherein said lower section of said housing is constructed of a flexible material which allows said housing to be positioned to face-outward in any direction to optimize the illumination of said lamp.

16. The assembly as specified in claim 15 wherein said flexible material is comprised of a corrugated “gooseneck” material.

17. The assembly as specified in claim 13 wherein the lower end of the upper section of said housing it terminated with a threaded cap from where projects a ball section of a universal type structure, and wherein the upper end of the lower section of said housing terminates with a threaded cap from where projects a ball-receptor section of said universal-type structure, wherein said universal-type structure allows said housing to be positioned to fare outward in any direction to optimize the illumination of said assembly.

18. The assembly as specified in claim 13 wherein said LED can incorporate a built-in blinking circuit which causes said LED to blink when power is applied.
